(19) United States
(12) Patent Application Publication
(10) Pub. No.: US 2008/0136889 A1
(43) Pub. Date: Jun. 12, 2008

(54) IMAGE FORMING ELEMENT AND ITS MANUFACTURING APPARATUS AND METHOD

(75) Inventors: Eung-Yeoul Yoon, Yongin-si (KR); Kae Dong Back, Yongin-si (KR); Kyu Ho Shin, Yongin-si (KR); Jin Seung Choi, Suwon-si (KR); Soon Cheol Kweon, Yongin-si (KR); Su Ho Shin, Yongin-si (KR); Ki Hwan Kwon, Yongin-si (KR); Chang Youl Moon, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/735,097

(22) Filed: Apr. 13, 2007

(30) Foreign Application Priority Data
Dec. 6, 2006 (KR) 10-2006-0123341

(51) Int. Cl. C04B 35/00; B29C 33/44; B41J 2/39

(52) U.S. Cl. 347/141; 264/104; 425/317; 399/119

(57) ABSTRACT

An image forming element and its manufacturing apparatus and method are disclosed, in which manufacturing process steps can be simplified to reduce the cost and improve productivity. The manufacturing method of an image forming element includes respectively providing a mold and an image drum, forming line shaped conductive paste patterns on the mold, and transferring the conductive paste patterns from the mold onto the image drum.

### CROSS-REFERENCE TO RELATED APPLICATIONS

This application claims priority from Korean Patent Application No. 10-2006-0123341, filed on Dec. 6, 2006, in the Korean Intellectual Property Office, the disclosure of which is incorporated herein by reference in its entirety.

### BACKGROUND OF THE INVENTION

1. Field of the Invention

Methods and apparatuses consistent with the present invention relate to an image forming element for selectively adsorbing a toner for image formation and, more particularly, to an image forming element and its manufacturing apparatus and method.

2. Description of the Related Art

FIG. 1 is a side view illustrating a structure of an image forming apparatus using a related art ring conductor, FIG. 2 is a schematic perspective view illustrating a related art image forming apparatus, and FIG. 3 is an enlarged cross-sectional view illustrating a portion of the circumferential wall of the image forming element of FIG. 2. The image forming element shown in FIGS. 2 and 3 is disclosed in U.S. Pat. No. 6,014,157, which is incorporated herein by reference in its entirety.

Referring to FIGS. 1 through 3, the related art image forming apparatus includes a toner supply unit 40, an image forming element 10 to which a toner 1 is adsorbed from the toner supply unit 40 by an electrostatic force, a magnetic cutter 50 separating a part of the toner 1 adsorbed to the image forming element 10, and a toner return unit 60 that returns the toner 1 separated by the magnetic cutter 50 to the toner supply unit 40.

The toner supply unit 40 supplies the toner 1 from a toner storage unit 41 by using a toner supply roller 42. The image forming element 10 includes an image drum 12 and a plurality of ring electrodes 14 disposed on the image drum 12. Also, a control unit 16 is installed inside of the image drum 12 to independently apply a voltage to each of the ring electrodes 14. The magnetic cutter 50, which is able to separate the toner 1 adsorbed to the image forming element 10, is provided outside of the image drum 12.

In this structure, a part of the toner 1, transferred to the image forming element 10 from the toner supply unit 40, can be separated from the image forming element 10 through the magnetic cutter 50. The toner 1 remaining on the image forming element 10 can finally be transferred to a printing paper through an image transfer unit 70, and the printing paper is heated, thereby fixing the toner 1 to the printing paper.

However, the related art image forming apparatus has problems in that it is difficult and expensive to manufacture or repair the image forming element 10. Particularly, although the ring electrodes 14 of the image forming element 10 may be designed variously depending on required resolution, it is required that grooves having a width of approximately 20 μm should be formed uniformly at constant intervals of 42.3 μm or less on the image drum 12 by using a precise cutting tool to form the ring electrodes having a resolution of 600 dpi (dots per inch) or greater. Because it is difficult to uniformly form grooves of fine intervals on the cylindrical image drum 12, the manufacturing cost of the image forming element 10 increases, and there is an increased likelihood of a defect. Also, to electrically connect each of the ring electrodes 14 with the control unit 16, holes connected with each other should be formed inside and outside of the image drum 12 and should be filled with conductive materials, thereby complicating related manufacturing process steps. This increases the number of the manufacturing process steps, which are expensive and time consuming. As a result, printers made using the related art image forming apparatus have a high cost, making popular acceptance for such printers difficult to achieve.

Accordingly, an image forming element and its manufacturing apparatus and method, in which manufacturing process steps can be simplified to reduce the cost and improve productivity is needed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides an image forming element and its manufacturing apparatus and method, in which manufacturing process steps are simplified to reduce the cost and improve productivity.

An aspect of the present invention also provides an image forming element and its manufacturing apparatus and method, in which ring electrodes of a micrometer sized unit are easily formed by an imprint process.

An aspect of the present invention also provides an image forming element and its manufacturing apparatus and method, which can lower the manufacturing cost, enable mass production, and improve process yield.

An aspect of the present invention also provides an image forming element and its manufacturing apparatus and methods which can improve precision of ring electrodes and reduce the incidence of a defect.

An aspect of the present invention also provides an image forming element and its manufacturing apparatus and method, in which an electrical connection structure between ring electrodes and a device for electrically controlling the respective ring electrodes is simplified.

In one aspect, the present invention relates to a method of manufacturing an image forming element. The method includes providing a mold and an image drum, forming line shaped conductive paste patterns on the mold, and transferring the conductive paste patterns from the mold onto the image drum.

The mold may include line patterns, and the conductive paste patterns may be formed along the line patterns. The line patterns are at least one of mechanical patterns or chemical patterns, which are formed of any one of negative patterns, positive patterns, and plane patterns. For example, the line patterns may be provided in a shape of a groove or projection, as mechanical patterns, or may be provided in a form of hydrophilic or hydrophobic portion formed on the mold surface, as chemical patterns. Specifically, the line patterns may be formed by a mechanical process, similar to a rough portion. Also, the line patterns may be formed by surface treatment to have different physical properties or may be formed by locally changing a material.

In another aspect, the present invention relates to a method of manufacturing an image forming element. The method includes providing a mold, wherein the mold includes negative patterns. An image drum is also provided. The method further includes filling imprintable conductive pastes on the negative patterns; and performing imprinting to allow the conductive pastes to be transferred onto a circumference of the image drum.

As described above, to conventionally form ring electrodes on the circumference of the image drum, the grooves should be formed on the image drum by using a precise cutting tool, holes should be formed inside and outside the image drum, and the grooves and holes should be filled with a conductive material after an oxide membrane is formed. Particularly, it is difficult to uniformly form the grooves of approximately 20 μm at a pitch of 42.3 μm on the cylindrical image drum. For this reason, problems occur in that the manufacturing cost of the image forming element increases and the incidence of a defect increases.

However, in the manufacturing methods of the image forming element described in exemplary embodiments of the present invention, instead of the cutting process, the imprinting process is performed such that the conductive pastes are transferred onto the circumference of the image drum, thereby easily forming the ring electrodes of micrometer sized unit.

The mold may be formed of a rigid material. In one exemplary embodiment, the mold may be formed of a flexible material. For example, the mold may be formed of polydimethylsiloxane (PDMS) or polyethylene terephthalate (PET).

The negative patterns may be formed on the mold to form line shapes, and may be arranged in parallel to be spaced apart from one another at constant intervals. The negative patterns may be formed in the form of fine patterns so that the ring electrodes may develop an image of a high resolution.

An insulating layer may be formed on the circumference of the image drum. The insulating layer may be formed of various materials having different surface energies depending on required conditions. For example, the insulating layer may be formed of parylene or a typical polymer having excellent electrical insulating property. Depending upon embodiments, the insulating layer may be formed of an oxide membrane layer by an anodizing process. Otherwise, the image drum may be formed of an insulating material instead of the insulating layer.

The image drum may include a substrate provided with connecting patterns. The substrate is provided on the image drum so that one end of each connecting pattern is exposed to the outside of the image drum. The connecting patterns are formed in the form of fine patterns and spaced apart from one another at fine intervals. An ordinary flexible printed circuit board (FPCB) may be used as the substrate. In one exemplary embodiment, the substrate may be formed of a rigid material that can form the connecting patterns of fine patterns. Also, a control device for electrical control of the ring electrodes may be provided on the substrate.

To fill the conductive pastes on the negative patterns, various methods may be used. As an example, after the conductive pastes are entirely coated on the mold provided with the negative patterns, the top surface of the mold is pushed by a squeeze plate so that the conductive pastes may independently be filled on the negative patterns. In one exemplary embodiment, the conductive pastes may independently be filled on the negative patterns by a separate dispenser.

Various methods may be used to transfer the conductive pastes filled on the negative patterns onto the image drum. As an example, after the mold provided with the conductive pastes respectively filled on the negative patterns is fixed, the image drum is rotated above the mold so that the conductive pastes filled on the negative patterns may be transferred onto the circumference of the image drum. In one exemplary embodiment, after the image drum is fixed, the mold may be wound along the circumference of the image drum so that the conductive pastes on the mold may be transferred onto the image drum.

Adhesion, transfer, and resolution of the conductive pastes with respect to the mold and the image drum may depend on a correlation of physical properties of the conductive pastes, the mold, and the image drum. As an example, as the surface energy of the image drum becomes greater than the surface energy of the mold, the conductive pastes have excellent transfer property. By contrast, when the surface energy of the conductive pastes is greater than surface tension of the image drum, resolution of the conductive pastes improve, however adhesion and transfer to the image drum degrade.

The conductive pastes on the mold may be transferred onto the circumference of the image drum and at the same time electrically connected with the connecting patterns externally exposed from the image drum. In this case, the connecting patterns have the same width as that of the conductive pastes transferred onto the circumference of the image drum and are spaced apart from one another at the same pitch as that of the conductive pastes so that the connecting patterns are electrically connected with the conductive pastes one to one.

An image forming element manufactured by the manufacturing method according to an exemplary embodiment of the present invention may be applied to an image forming apparatus which includes a toner supply unit, a magnetic cutter, and a toner return unit. In one exemplary embodiment, the image forming element may be applied to an image forming apparatus excluding any one of the toner supply unit, the magnetic cutter, and the toner return unit or additionally including any other units.

In another aspect, the present invention relates to a manufacturing apparatus for manufacturing an image forming element. The manufacturing apparatus includes a mold provided with line patterns and a drum driver arranged to be adjacent to the mold. The mold is configured to rotatably support the image drum and rotate the image drum to allow conductive pastes provided on the line patterns to be transferred onto the image drum.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a side view illustrating a structure of a related art image forming apparatus;

FIG. 2 is a schematic perspective view illustrating a structure of a related art image forming element;

FIG. 3 is an enlarged cross-sectional view illustrating a portion of the circumferential wall of the image forming element of FIG. 2;

FIG. 4 is a flowchart illustrating a manufacturing method of an image forming element according to an exemplary embodiment of the present invention;

FIGS. 5 to 8 illustrate manufacturing process steps of an image forming element according to an exemplary embodiment of the present invention;

FIGS. 9 and 10 are a perspective view and a cross-sectional view illustrating a structure of the image forming element manufactured by a manufacturing method according to an exemplary embodiment of the present invention;

FIG. 11 is a perspective view illustrating a structure of a substrate of an image forming element manufactured by a manufacturing method according to an exemplary embodiment of the present invention;

FIG. 12 is a side view illustrating a structure of an image forming apparatus to which an image forming element is applied, manufactured by a manufacturing method according to an exemplary embodiment of the present invention; and

FIGS. 13 to 15 illustrate a manufacturing method of an image forming element according to another exemplary embodiment of the present invention.

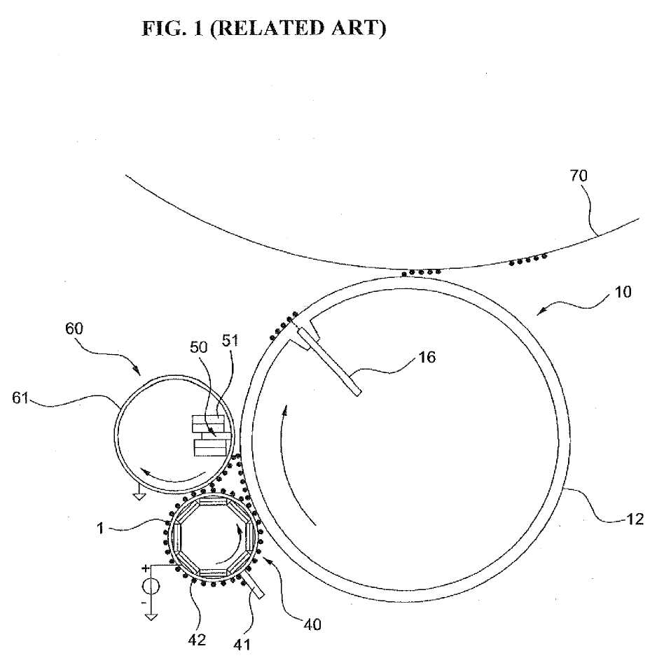

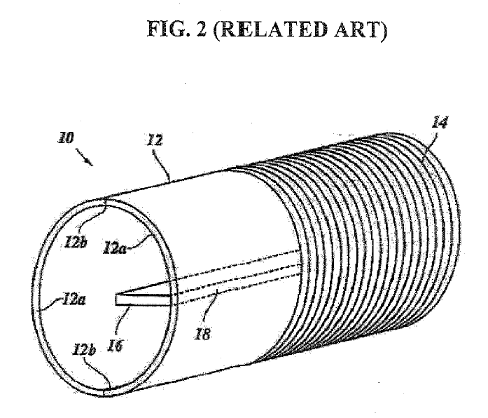

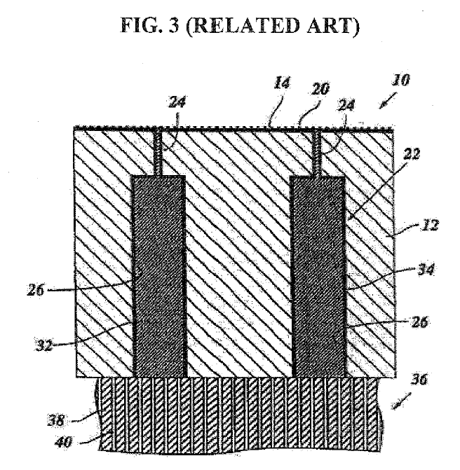

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout.

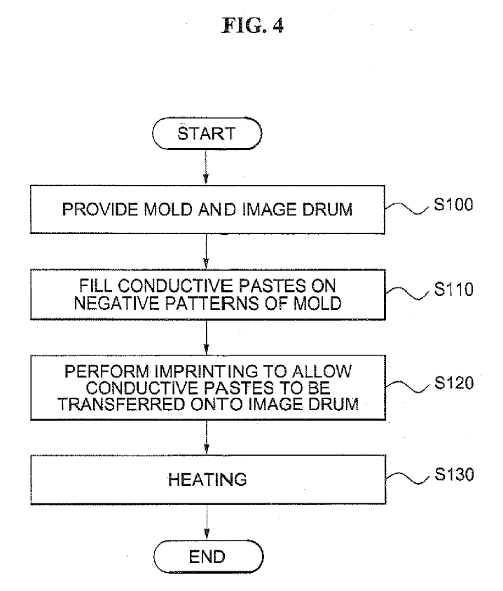

In FIGS. 4 through 8, an image forming element and a manufacturing method in accordance with exemplary embodiments of the present invention are shown. As shown in FIG. 4, the image forming element can be manufactured by providing a mold 200 with negative patterns 210 and an image drum 120 in operation S100, filling imprintable conductive pastes 122′ on the negative patterns 210 in operation S110, and performing imprinting to allow the conductive pastes 122′ to be transferred onto the circumference of the image 120 in operation S120.

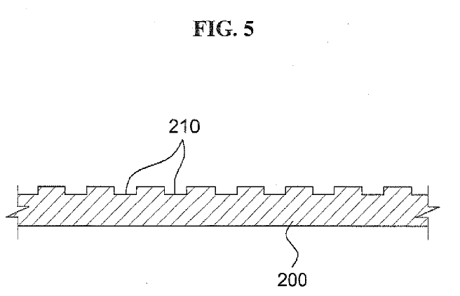

Operation S100 in which the mold and the image drum are provided, is shown in FIG. 5. The mold 200 includes the negative patterns 210. The mold 200 may be formed of a rigid material. In some exemplary embodiments, the mold 200 may be formed of a flexible material. As an example, the mold 200 may be formed of polydimethylsiloxane (PDMS) or polyethylene terephthalate (PET).

Since the mold of PDMS or PET is flexible and has low surface energy, the conductive pastes can easily be removed from the mold. Specifically, the conductive pastes can easily be transferred onto the image drum during imprinting. When the negative patterns are filled with the conductive pastes at a depth of 3 μm or greater, the conductive pastes can easily be filled on the negative patterns by a capillary force. Also, the mold of PDMS or PET has advantages in view of its low cost and easy reprinting.

The negative patterns 210 are formed on the mold 200 to form a line shape, and are arranged in parallel to be spaced apart from one another at constant intervals. The negative patterns 210 are formed in the form of fine patterns so that ring electrodes 122 may develop an image of a high resolution. The ring electrodes 122 will be described later in detail. For example, the negative patterns 210 may have a width of 5 μm to 30 μm, may be spaced apart from one another at a pitch of 10 μm to 50 μm, and may be provided in parallel. Also, the negative patterns 210 may be formed by either a typical etching or a typical processing method such as a mechanical process.

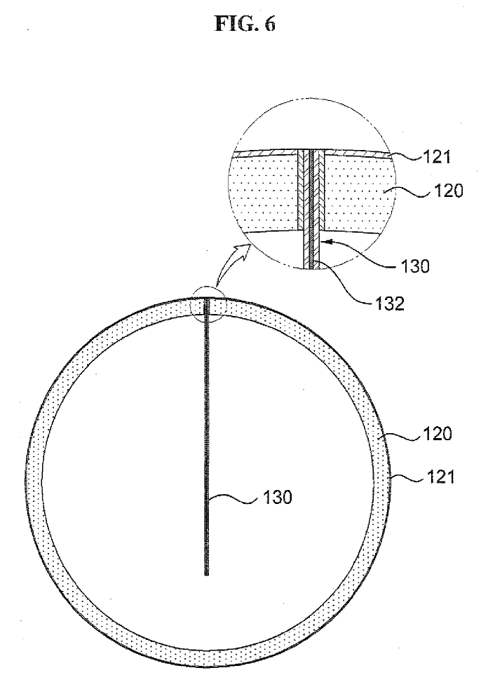

Next, as shown in FIG. 6, the image drum 120 is prepared. The image drum 120 has a hollow cylindrical shape and may be formed of aluminum. An insulating layer 121 may be formed on the circumference of the image drum 120. The insulating layer 121 may be formed of various materials having different surface energies depending on required conditions. For example, the insulating layer 121 may be formed of parylene or a typical polymer having excellent electrical insulating property. Depending upon embodiments, the insulating layer 121 may be formed of an oxide membrane layer by an anodizing process. In one exemplary embodiment of the present invention, the insulating layer 121 is separately provided on the circumference of the image drum 120. However, in another exemplary embodiment, the image drum itself may be formed of an insulating material, which allows for the insulating layer to be excluded.

To easily transfer the conductive pastes onto the image drum, surface energy of the insulating layer should be greater than that of the mold. Specifically, since the surface energy of the insulating layer of parylene is greater than that of the mold of PDMS or PET, the conductive pastes can easily be transferred onto the image drum. The insulating layer of parylene can easily be manufactured using a simple cutting process. Parylene also has excellent durability and abrasion resistance.

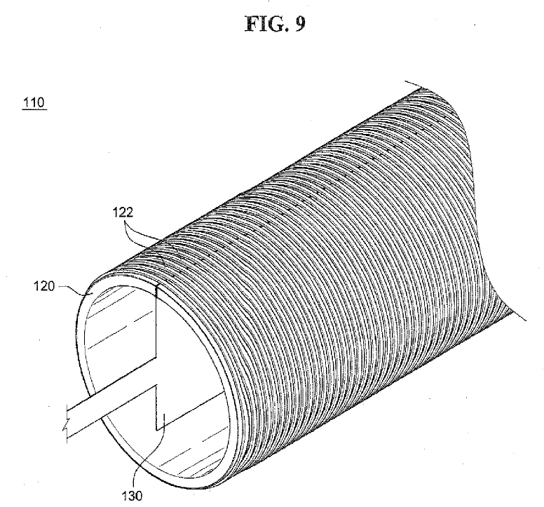

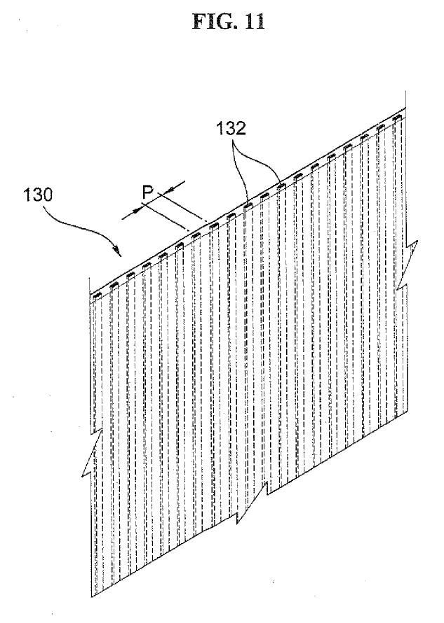

As shown in FIGS. 9 to 11, the image drum 120 may include a substrate 130 provided with connecting patterns 132. The substrate 130 is provided on the image drum 120 so that one end of each connecting pattern 132 is externally exposed from the image drum 120.

The connecting patterns 132 are formed on one surface of the substrate 130 and spaced apart from one another in a coplanar and parallel pattern. In one exemplary embodiment of the present invention, the connecting patterns 132 are received in the substrate 130 formed of an insulating material, such as those described above. In another exemplary embodiment, the connecting patterns 132 may be formed so that at least one side is externally exposed from the side of the substrate 130.

The substrate 130 may be formed of a flexible material, and the connecting patterns 132 are formed of fine patterns at fine intervals. As an example, the connecting patterns 132 may be formed to be spaced apart from one another at a pitch (P) of 10 μm to 50 μm. A flexible printed circuit board (FPCB) may be used as the substrate 130. In one exemplary embodiment, the substrate may be formed of a rigid material that can form connecting patterns of fine patterns.

The substrate 130 may be arranged inside the image drum 120 in a substantially straight line. Alternatively, the substrate 130 may be arranged in a winding state or in a predetermined folding or bending state.

As described above, the substrate 130 serves to connect the ring electrodes 122 formed on the circumference of the image drum 120 with the inside of the image drum 120. In one exemplary embodiment, a control device (not shown) for electrical control of the ring electrodes 122 may be provided on the substrate 130 in a single body. The substrate 130 provided with the control device in a single body serves to connect the ring electrodes 122 with the inside of the image drum 120, and at the same time can constitute a circuit that controls the ring electrodes 122 along with the control device. The control device may include a plurality of control chips to independently apply a voltage to each of the ring electrodes 122. The control chip may be, for example, an application-specific integrated circuit (ASIC).

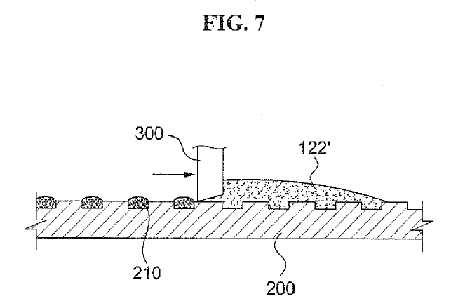

Turning to FIG. 7, conductive pastes 122′ that can be imprinted are filled on the negative patterns 210 of the mold 200. The conductive pastes 122′ include a main component of a conductive metal material such as silver (Ag), and may further include various solvents. Also, viscosity of the conductive pastes 122′ may depend on the required condition.

To fill the conductive pastes 122′ on the negative patterns 210, various methods may be used. As an example, after the conductive pastes 122′ are entirely coated on the mold 200 provided with the negative patterns 210, the top surface of the mold 200 is pushed by a squeeze plate 300 so that the conductive pastes 122′ may independently be filled on the negative patterns 210. In one exemplary embodiment, the conductive pastes 122′ may be independently filled on the negative patterns 210 by a separate dispenser (not shown).

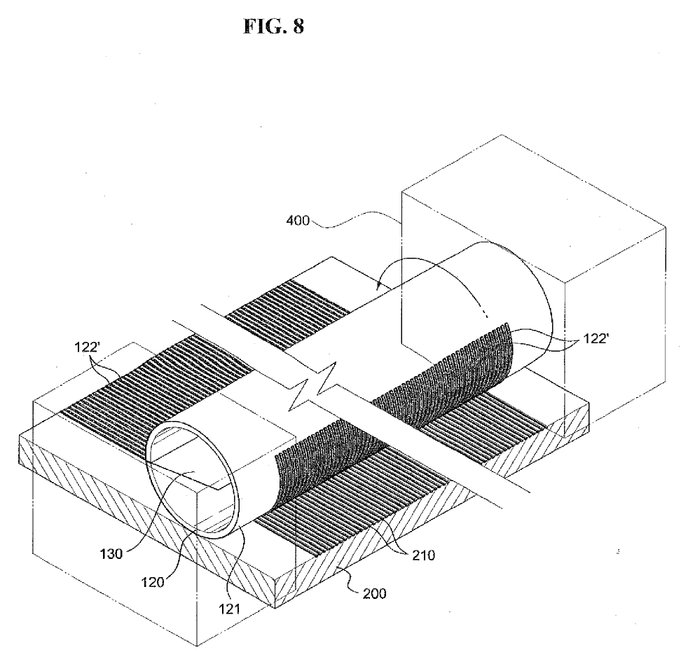

Next, as shown in FIG. 8, imprinting is performed such that the conductive pastes 122′ filled on the negative patterns 210 are transferred onto the circumference of the image drum 120. Various methods may be used to transfer the conductive pastes 122′ filled on the negative patterns 210 onto the image drum 120. As an example, after the mold 200 provided with the conductive pastes 122′ respectively filled on the negative patterns 210 is fixed, the image drum 120 is rotated above the mold 200 so that the conductive pastes 122′ filled on the negative patterns 210 may be transferred onto the circumference of the image drum 120. At this time, the image drum 120 may be rotated in a state that the image drum 120 is spaced apart from the top surface of the mold 200 at a predetermined interval. In one exemplary embodiment, the image drum 120 may be rotated in a state that the image drum 120 is in contact with the top surface of the mold 200.

In one exemplary embodiment, the image drum 120 is rotated along a longitudinal direction of the negative patterns 210 so that the conductive pastes 122′ on the mold 200 may be transferred onto the image drum 120. However, in another exemplary embodiment, the image drum 120 may be rotated in a direction perpendicular to the longitudinal direction of the negative patterns 210 so that the conductive patterns 122′ on the mold 200 may be transferred onto the image drum 120.

Furthermore, to transfer the conductive pastes 122′ filled on the negative patterns 210 onto the image drum 120, after the image drum 120 is fixed, the mold 200 is wound along the circumference of the image drum 120 so that the conductive pastes 122′ on the mold 200 may be transferred onto the image drum 120.

Adhesion, transfer, and resolution of the conductive pastes 122′ with respect to the mold 200 and the image drum 120 may depend on a correlation of physical properties of the conductive pastes 122′, the mold 200, and the image drum 120. As an example, as the surface energy of the image drum 120 becomes greater than the surface energy of the mold 200, the conductive pastes 122′ have excellent transfer property. By contrast, when the surface energy of the conductive pastes 122′ is greater than surface tension of the image drum 120, resolution of the conductive pastes 122′ improves, but the adhesion and transfer to the image drum 120 degrade.

The conductive pastes 122′ on the mold 200 are transferred onto the circumference of the image drum 120 and at the same time are electrically connected with the connecting patterns 132 externally exposed from the image drum 120. In this case, the connecting patterns 132 have the same width as that of the conductive pastes 122′ transferred onto the circumference of the image drum 120 and are spaced apart from one another at the same pitch as that of the conductive pastes 122′ so that the connecting patterns 132 are electrically connected with the conductive pastes 122′ one to one.

Afterwards, heating is performed in operation S130 such that the conductive pastes 122′ transferred onto the circumference of the image drum 120 may be cured, whereby the plurality of ring electrodes 122 are formed on the circumference of the image drum 120. In this case, heating means a curing process. The curing process can volatilize the solvents included in the conductive pastes 122′ and cure the conductive pastes 122′. Those having ordinary skill in the art will appreciate that alternative curing processes may used, depending on the material properties of the conductive pastes 122′, without departing from the scope of the present invention.

In one exemplary embodiment, an insulating film 123 of a typical dielectric material may be formed on the circumference of each of the ring electrodes 122.

The aforementioned manufacturing method can be realized by a manufacturing apparatus of the image forming element, which includes a mold and a drum driver. Specifically, as shown in FIG. 8, the manufacturing apparatus of the image forming element includes a mold 200 provided with line patterns 210 and a drum driver 400 arranged to be adjacent to the mold 200. The drum driver 400 rotatably supports the image drum 120 and rotates the image drum 120 so that the conductive pastes 122′ provided on the line patterns may be transferred onto the image drum 120.

The mold 200 may be formed of a rigid material. In one exemplary embodiment, the mold 200 may be formed of a flexible material. For example, the mold 200 may be formed of PDMS or PET.

The line patterns are formed on the mold in the form of lines. Mechanical patterns or chemical patterns comprised of any one of negative, positive, and plane forms may be used as the line patterns. Specifically, the line patterns may be formed by a mechanical process, similar to a rough portion. Also, the line patterns may be formed by surface treatment to have different physical properties or by locally changing a material.

The drum driver 400 can include a rotational shaft, a driving motor generating a driving force, and a control unit controlling the driving motor. The image drum 120 can be rotated with respect to the mold 200 by the drum driver 400, and the conductive pastes 122′ provided on the line patterns can be transferred onto the image drum 120.

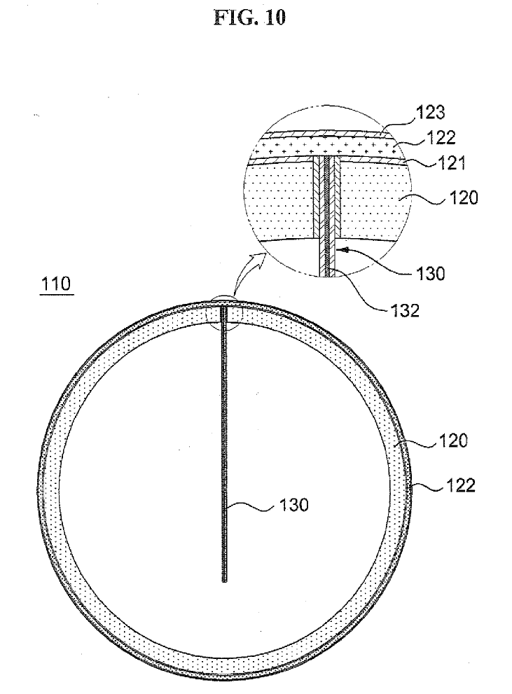

The image forming element 110 shown in FIGS. 9 and 10 can be manufactured by the aforementioned manufacturing methods and apparatuses. The image forming element 110 can be used for selectively adsorbing a toner from an image forming apparatus.

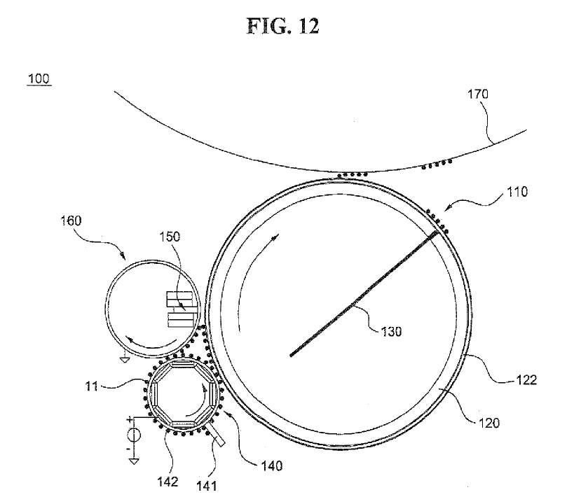

FIG. 12 is a side view illustrating a structure of an image forming apparatus to which the image forming element manufactured by the manufacturing method according to an exemplary embodiment of the present invention is applied. As shown in FIG. 12, the image forming element 110 manufactured by the aforementioned manufacturing method is applied to the image forming apparatus 100, which includes a toner supply unit 140, a magnetic cutter 150, and a toner return unit 160. Those having ordinary skill in the art will appreciate that the image forming apparatus may exclude any one of the toner supply unit, the magnetic cutter, and the toner return unit or further include another unit without departing from the scope of the present invention.

The toner supply unit 140 supplies a toner 11 from a toner storage unit 141 by using a toner supply roller 142. The toner 11 can be adsorbed to the image forming element 110 from the toner supply unit 140 by an electrostatic force. A part of the toner 11 transferred from the toner supply unit 140 to the image forming element 110 can be separated from the image forming element 110 through the magnetic cutter 150. The toner 11 remaining on the image forming element 110 can finally be transferred to a printing paper through an image transfer unit 170. The printing paper is then heated, thereby fixing the toner 11 to the printing paper. The toner separated by the magnetic cutter 150 can be returned to the toner supply unit 140 through the toner return unit 160.

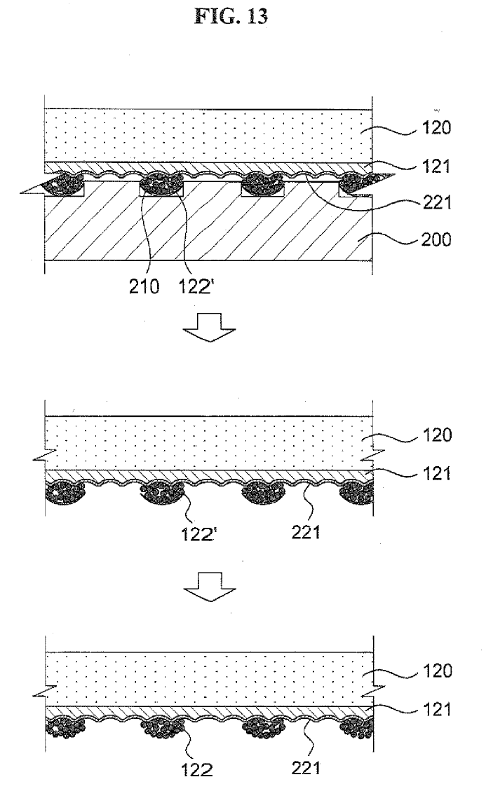

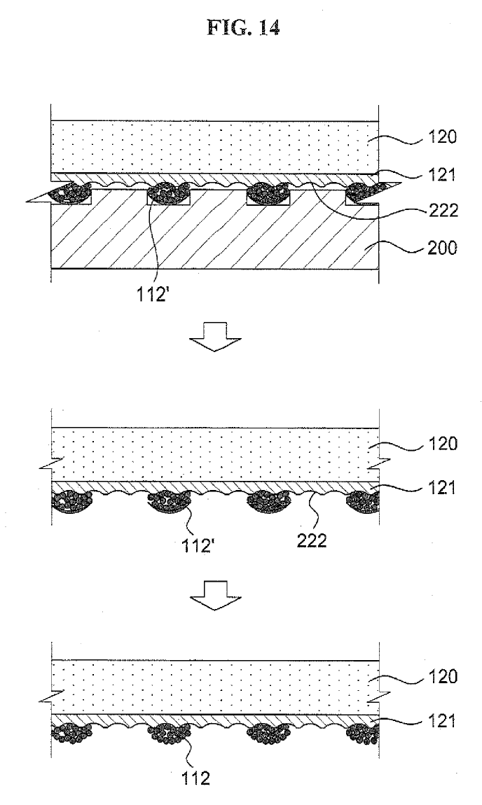

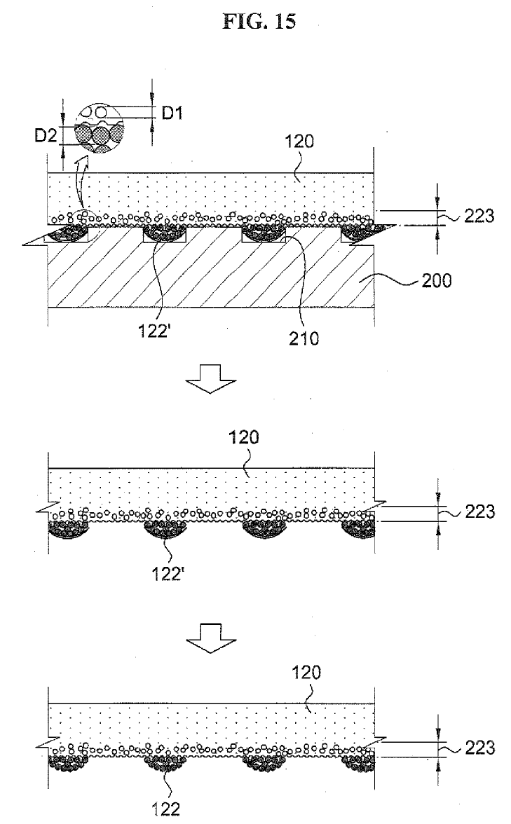

Turning to FIGS. 13 to 15, a manufacturing method of an image forming element according to another exemplary embodiment of the present invention is shown. Before the conductive pastes 122′ on the aforementioned mold 200 are transferred onto the image drum 120, i.e., before the imprinting of operation S120, the circumference of the image dm 120 may be treated so that the conductive pastes 122′ may stably be transferred onto the image drum 120. Also, three states are sequentially shown in FIGS. 13 to 15, in which: FIG. 13 illustrates the state in which the circumference of the image drum 120, which is surface-treated, is arranged to oppose the mold 200; FIG. 14 illustrates the state in which the conductive pastes 122′ are transferred onto the circumference of the image drum 120; and FIG. 15 illustrates the state in which the circumference of the image drum 120 is heated.

As shown in FIG. 13, in one exemplary embodiment, the insulating layer 121 may be formed on the circumference of the image drum 120, wherein the circumference of the insulating layer 121 may be surface-treated. The insulating layer 121 may be formed of parylene. The insulating layer may be surface-treated so that a typical primer is coated on the circumference of the insulating layer 121 to form a primer rough surface 221 on the circumference of the insulating layer 121. In other exemplary embodiments, the insulating layer 121 may be formed of a typical polymer having excellent insulating property or may be formed of an oxide membrane layer by anodizing.

In another exemplary embodiment, the insulating layer 121 may be formed on the circumference of the image drum 120, and may be surface-treated by a typical ashing process, as shown in FIG. 14. For example, the insulating layer 121 may be formed of parylene, and a rough surface 222 may be formed on the circumference of the insulating layer 121 by an ashing process. In this case, the insulating layer 121 may be formed of various materials having different characteristics depending on the required condition.

In another exemplary embodiment, the image drum 120 may be surface-treated to form a porous surface 223 on the circumference, as shown in FIG. 15. The porous surface 223 may be formed by anodizing the circumference of the image drum 120 made of aluminum. Also, when the conductive pastes 122′ are transferred onto the porous surface 223 formed by the surface-treatment process, adjacent conductive pastes 122′ are electrically connected with each other. In one exemplary embodiment, a pore effective diameter D1 of the porous surface 223 is smaller than a particle effective diameter D2 of the conductive pastes 122′ to prevent a short from occurring. For example, the particle effective diameter D2 of the conductive pastes 122′ may be formed at a size of several hundreds of nm to 1 μm, and the pore effective diameter D1 of the porous surface may be formed at a size of several nm to several tens of nm.

Image forming apparatuses and manufacturing methods and apparatuses may have one or more of the following advantages.

Since the structure and the manufacturing process steps are simplified by the image forming apparatus according to the present invention, cost may be reduced and productivity may be increased.

Particularly, it is possible to easily form the ring electrodes of a micrometer sized unit through the imprinting process.

Furthermore, it is possible to reduce the manufacturing cost, enable mass production, and improve process yield.

Furthermore, it is possible to improve precision of the ring electrodes and reduce the incidence of a defect.

Finally, it is possible to simplify the electrical connection structure between the ring electrodes and the control device for electrically controlling each of the ring electrodes.

Although the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of manufacturing an image forming element, comprising:
providing a mold and an image drum;
forming line shaped conductive paste patterns on the mold; and
transferring the conductive paste patterns from the mold onto the image drum.

2. The method of claim 1, wherein the mold includes line patterns, and wherein the conductive paste patterns are formed along the line patterns.

3. The method of claim 2, wherein the line patterns are at least one of mechanical patterns and chemical patterns.

4. The method of claim 1, further comprising:
surface-treating a circumference of the image drum before transferring the conductive paste patterns onto the image drum.

5. A method of manufacturing an image forming element, comprising:
providing a mold, wherein the mold comprises negative patterns;
providing an image drum;
filling imprintable conductive pastes on the negative patterns; and
performing imprinting to allow the conductive pastes to be transferred onto a circumference of the image drum.

6. The method of claim 5, wherein the negative patterns have a width of about 5 μm to about 30 μm, are spaced apart from one another at a pitch of 10 μm to 50 μm, and are provided in parallel.

7. The method of claim 5, wherein the mold is formed of polydimethylsiloxane (PDMS) or polyethylene terephthalate (PET).

8. The method of claim 7, wherein the image drum comprises an insulating layer formed of parylene on the circumference before the imprinting.

9. The method of claim 5, further comprising forming an insulating layer on the circumference of the image drum before the imprinting.

10. The method of claim 9, wherein the insulating layer is formed of parylene.

11. The method of claim 5, further comprising:
surface-treating the circumference of the image drum before the imprinting.

12. The method of claim 11, wherein the surface-treating of the circumference of the image drum comprises coating a primer on the circumference of the image drum.

13. The method of claim 11, wherein the surface-treating of the circumference of the image drum comprises forming a rough surface on the circumference of the image drum through an ashing process.

14. The method of claim 11, wherein the surface-treating of the circumference of the image drum comprises forming a porous surface on the circumference of the image drum.

15. The method of claim 14, wherein the porous surface has a pore effective diameter smaller than a particle effective diameter of the imprintable conductive pastes.

16. The method of claim 5, wherein the imprinting comprises rotating the image drum with respect to the mold to transfer the imprintable conductive pastes onto the circumference of the image drum.

17. The method of claim 5, further comprising:
heating the imprintable conductive pastes transferred onto the circumference of the image drum.

18. The method of claim 5, wherein the image drum comprises a substrate provided with connecting patterns, and the imprintable conductive pastes are electrically connected with the connecting patterns during the imprinting.

19. The method of claim 18, wherein the connecting patterns are electrically connected with the imprintable conductive pastes one to one on the same line.

20. The method of claim 18, wherein the substrate is a flexible printed circuit board (FPCB).

21. An image forming element manufactured by the method of claim 1.

22. A manufacturing apparatus of an image forming element comprising:
a mold provided with line patterns; and
a drum driver arranged to be adjacent to the mold, wherein the drum driver is configured to rotatably support the image drum and rotate the image drum relative to the mold.

23. The manufacturing apparatus of claim 22, wherein the line patterns are at least one of mechanical patterns and chemical patterns.

24. The manufacturing apparatus of claim 22, wherein the mold is formed of polydimethylsiloxane (PDMS) or polyethylene terephthalate (PET).
